(19) United States
(12) Patent Application Publication
(10) Pub. No.: US 2025/0234926 A1
(43) Pub. Date: Jul. 24, 2025

(54) HEATING ELEMENT, ATOMIZING MEMBER, ATOMIZING DEVICE, AND ELECTRONIC CIGARETTE

(71) Applicant: Shenzhen Eigate Technology Co., Ltd., Shenzhen (CN)

(72) Inventor: Tuanfang LIU, Shenzhen (CN)

(21) Appl. No.: 19/031,063

(22) Filed: Jan. 17, 2025

(30) Foreign Application Priority Data
Jan. 22, 2024 (CN) 202410087020.0
Jan. 22, 2024 (CN) 202420155842.3

(51) Int. Cl. A24F 40/46; A24F 40/10; A24F 40/44; A24F 40/485; A24F 40/53; H05B 3/22

(52) U.S. Cl. CPC A24F 40/46; A24F 40/10; A24F 40/44; A24F 40/485; A24F 40/53; H05B 3/22

(57) ABSTRACT

A heating element for atomizing an atomizing substance to form an aerosol, including a base and a temperature measurement device. The base includes a heating section. The heating section includes a surface, a heating layer disposed on the surface, and a plurality of holes arranged in a predetermined pattern. The plurality of holes is configured to adsorb an atomizing substance and direct the adsorbed atomizing substance to the heating layer. The temperature measurement device is disposed on the base for measuring the temperature of the heating section.

### CROSS-REFERENCE TO RELATED APPLICATIONS

Pursuant to 35 U.S.C. § 119 and the Paris Convention Treaty, this application claims foreign priority to Chinese Patent Application No. 202410087020.0 filed Jan. 22, 2024, and to Chinese Patent Application No. 202420155842.3 filed Jan. 22, 2024. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of atomization technology, and more particularly to a heating element, atomizing member, atomizing device, and electronic cigarette.

An electronic cigarette (also referred to as an “e-cigarette”) or vaping device is an electronic delivery system used to atomize an atomizing substance to generate an aerosol for inhaling by a user. The atomizing substance may be a liquid (e.g., e-liquid, etc.) or a solid or gel (e.g., tobacco cream).

Typically, conventional e-cigarettes primarily include an atomizing device that stores the atomizing substance and a power supply. The atomizing device includes a heating or vaporizing device, such as an atomizer including an atomizing member, and the power supply provides power to the atomizer so that the atomizing substance in the atomizing device is converted into an aerosol for the user to inhale. In many e-cigarettes, inhalation by the user activates the atomizing device to vaporize the liquid atomizing substance in the atomizing device, and the user then inhales the resulting aerosol through the mouthpiece.

The atomizer is a key component of the e-cigarette, and directly affects the heating and the formation of the aerosol, thereby affecting the user's experience. The heating elements in the existing atomizers have problems such as unstable heating and easiness to burn the atomizer.

### SUMMARY

In one aspect, the disclosure provides a heating element for atomizing an atomizing substance to form an aerosol, the heating element comprising: a base, the base comprising a heating section, the heating section comprising a surface, a heating layer disposed on the surface, and a plurality of holes arranged in a predetermined pattern, the plurality of holes being configured to adsorb an atomizing substance and direct the adsorbed atomizing substance to the heating layer; and a temperature measurement device, the temperature measurement device being disposed on the base for measuring a temperature of the heating section.

In another aspect, the disclosure provides an atomizing member, comprising:
a cartridge, the cartridge comprising an airflow inlet, an airflow outlet, and an accommodation space and an atomizing substance inlet between the airflow inlet and the airflow outlet, the accommodation space communicating with the atomizing substance inlet;
an atomizing base disposed in the accommodation space, the atomizing base comprising an atomizing channel and an opening, both the atomizing channel and the opening communicating with the airflow inlet and the airflow outlet, and the opening communicating with the atomizing substance inlet and the atomizing channel; and
the heating element disposed in the atomizing base, the heating layer facing the atomizing channel, a surface of the heating element opposite the heating layer facing the atomizing substance inlet.

The disclosure further provides an atomizing device, comprising: the atomizing member and a housing; the atomizing member is disposed in the housing, and a storage chamber is formed between the atomizing member and the housing to accommodate the atomizing substance.

The disclosure also provides an electronic cigarette, comprising: the atomizing device, and a power supply for supplying power for the atomizing device.

The heating element of the disclosure comprises a base and a temperature measurement device integrated with the base, and a heating layer and a plurality of holes are disposed in a preset rule in the heating section of the base for adsorbing an atomizing substance. Thus, the atomizing substance can reach the heating layer directly through the plurality of holes, thus increasing the uniformity of providing the atomizing substance through the heating element, making the heating more uniform. In addition, the temperature of the heating section can be accurately controlled by the temperature measuring device on the base, avoiding problems such as a burned core arising from an excessively high heating temperature. As a result, the aerosol formed is induced to be softer and more consistent. Furthermore, by installing a plurality of holes for e-liquid conduction directly in the base, the number of parts of the heating element can be reduced, and the thickness of the heating element is reduced.

### BRIEF DESCRIPTION OF THE DRAWINGS

FIG. 1 is a schematic diagram of a heating element according to one embodiment of the disclosure;

FIG. 2 is a schematic diagram of an atomizing member comprising the heating element in FIG. 1;

FIG. 3 is an exploded view of an atomizing member in FIG. 2;

FIG. 4 is a combination of the heating element in FIG. 1 and electrodes;

FIG. 5 is an exploded view of an electronic cigarette comprising the atomizing member in FIG. 2; and

FIG. 6 is a sectional view of an electronic cigarette in FIG. 5.

In the drawings, the following reference numbers are used:

1. Heating element; 10. Base; 20. Temperature measuring device; 11. Heating section; 12. Assembly section; 13. Recess; 31. First electrode contact; 32. Second electrode contact; 33. Third electrode contact; 14. Hole;

100. Atomizing member; 110. Cartridge; 120. Atomizing base; 111. Airflow inlet; 112. Airflow outlet; 113. Accommodation space; 114. Atomizing substance inlet;

121. Atomizing channel; 61. Absorbing material; 141. First electrode; 142. Second electrode; 143. Third electrode; 1411. First electrode spring; 1421. Second electrode spring; 1431. Third electrode spring; 115. Flange;

1100. Top cover; 1200. Main body; 1300. Bottom cover; 1400. Seal element; 1500. Control part; 1201. Storage chamber; 1101. Mouthpiece; 1301. Air inlet; 1202. Battery chamber;

3000. Electronic cigarette; 2000. Battery module.

### DETAILED DESCRIPTION

To further illustrate the disclosure, embodiments detailing an atomization device, a control method thereof, and a hookah comprising the same are described below. It should be noted that the following embodiments are intended to describe and not to limit the disclosure.

In this disclosure, unless otherwise specified, the terms “connected”, “fixed”, etc. are to be understood in a broad sense, e.g., either directly or indirectly through an intermediate medium, or as a connection within two elements or an interaction between two elements. For those of ordinary skill in the art, the specific meaning of the above terms in the disclosure may be understood in actual need.

As used herein, “communication” refers to fluid communication, i.e., a fluid (including a liquid and/or a gas) can flow from one component to another. In addition, as used herein, communication between two components may refer to direct connectivity between two components, e.g., at least partial alignment between two holes, or connectivity through an intermediate medium.

“Atomizing substance” means a mixture or auxiliary substance that can be atomized, in whole or in part, into an aerosol by an electronic or similar device.

The term “aerosol” refers to a colloidal dispersion system comprising small solid or liquid particles dispersed and suspended in a gaseous medium.

“Atomization device” means a device in which a stored atomizable substance is atomized into an aerosol by means of heat or ultrasound. An atomization member is one of the main components of an atomization device.

In the related art, the heating member of the atomization member mainly has the following two structures: one is a cotton heating core, and the other is a ceramic heating core. For the cotton heating core, the heating wire is usually wrapped around the periphery of the liquid-conducting cotton, and the cotton heating core is electrified through the battery power supply so that the heating wire is heated. After the heating wire reaches a certain temperature, the atomization substance adsorbed on the liquid-conducting cotton begins to evaporate. In the cotton heating core, the liquid-conducting cotton is in direct contact with the heating wire, and the atomization substance around the heating wire will be evaporated quickly by the heating wire, resulting in dry burning. After the atomization substance is evaporated, the liquid-conducting cotton is easily burned by the heating wire, affecting the taste of smoke. In addition, compared with the cotton heating core, the ceramic heating core includes ceramic sintered around the heating wire. Even if the ceramic has the characteristics of high temperature resistance, the sintered ceramic is prone to produce internal holes with irregular distribution, resulting in unstable taste.

The disclosure provides a heating element comprising a base and a temperature measurement device integrated with the base, and a heating layer and a plurality of holes are disposed in a preset rule in the heating section of the base for adsorbing an atomizing substance. Thus, the atomizing substance can reach the heating layer directly through the plurality of holes, thus increasing the uniformity of providing the atomizing substance through the heating element, making the heating more uniform. In addition, the temperature of the heating section can be accurately controlled by the temperature measuring device on the base, avoiding problems such as a burned core arising from an excessively high heating temperature. As a result, the aerosol formed is induced to be softer and more consistent. Furthermore, by installing a plurality of holes for e-liquid conduction directly in the base, the number of parts of the heating element can be reduced, and the thickness of the heating element is reduced.

The heating element of the disclosure can achieve the advantages of both the good taste of the cotton atomizing member and the high stability of the ceramic atomizing member, and meanwhile overcomes the problems of poor consistency of the ceramic atomizing member and poor durability of the cotton atomizing member in the related art. In addition, compared to the cotton atomizing member (which requires manual assembly by hand), the heating element of the disclosure can be automatically manufactured, thereby improving the production efficiency.

The atomizing member of the disclosure can be used in an electronic cigarette. In the context of the disclosure, “electronic cigarettes” refer to a system in which an atomizing substance, such as a tobacco liquid (specifically, e-liquid, etc.), is atomized or the like to generate an aerosol for a person to inhale, suck, chew, or snort, etc. In some examples, the e-cigarette comprises a storage chamber for storing the atomizing substance and an atomizing member for adsorbing and atomizing the atomizing substance to form an aerosol. The atomizing substance may be in a liquid form (e.g., e-liquid) or a solid or gel form (e.g., smoke paste), etc. It should be understood herein that the atomizing members of the disclosure may also be used in other devices that require atomization of an atomizing substance, such as, for example, medical atomizing devices, skin care instruments, aromatherapy devices, and the like.

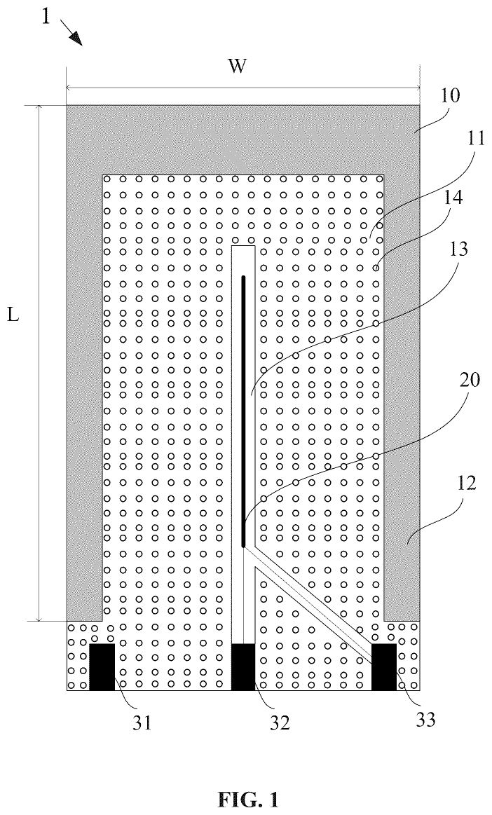

The heating element of the disclosure, as well as the atomizing member, are described in detail below with reference to FIGS. 1 to 4.

FIG. 1 is a schematic diagram of a heating element according to one embodiment of the disclosure.

As shown in FIG. 1, the heating element 1 for atomizing an atomizing substance to form an aerosol comprises a base 10 and a temperature measurement device 20.

The base 10 comprises a heating section 11, a heating layer (not shown) is disposed on the surface of the heating section 11, and a plurality of holes 14 arranged in a predetermined pattern are disposed inside the heating section 11. The plurality of holes 14 are used to adsorb an atomizing substance and direct the adsorbed atomizing substance to the heating layer.

The temperature measurement device 20 is disposed on the base 10 for measuring the temperature of the heating section 11.

In the above-described embodiment, the atomizing substance reaches the heating layer under the absorption and guiding effect of the plurality of holes arranged in a predetermined rule within the heating section 11 of the base 10 to be heated and atomized at the heating layer. The above design can improve the uniformity rate of the atomizing substance through the plurality of holes 14 arranged according to a predetermined rule (i.e., distributed with a certain regularity) in the heating section 11 of the base 10, and can control the temperature of the heating section 11 by means of the temperature measuring device 20 integrated with the base 10, so as to avoid problems such as burned cores caused by an excessively high heating temperature. This can lead to the formation of a softer and more consistent aerosol. In addition, by providing a plurality of holes 14 for e-liquid conduction directly in the base 10, it is also possible to reduce the number of components of the heating element 1 and to reduce the thickness of the heating element 1.

In some embodiments, a plurality of holes within the heating section 11 of the base 10 can adsorb and guide the atomizing substance by capillary action, which can avoid direct contact between the heating layer and the atomizing substance, and further avoid the atomizing substance (e.g., e-liquid) from impacting the heating layer at a flow rate that is too fast and causing it to enter the atomizing channel directly without atomization.

In some embodiments, the base 10 may be made of silicon wafers (also known as wafers). The silicon wafers refer to a sheet-like object made of silicon as the material, and silicon wafers with specifications such as 6-inch, 8-inch, and 12 inch can be made into the bases. Silicon wafers include monocrystalline silicon wafers, polycrystalline silicon wafers, etc. By using the silicon wafer as the base 10, a heating layer having micrometer-sized holes and having a low resistance value can thus be made in the silicon wafer with high precision using a chip fabrication process (e.g., photolithography, etc.), and optionally, a chip production line can be utilized for large-scale and automated fabrication of the heating layer.

In some other embodiments, the base 10 may also be made of glass, for example. The glass is, for example, quartz glass, high silica glass, and the like. Quartz glass includes, but is not limited to, natural quartz glass, synthetic quartz glass, clear quartz glass, opaque quartz glass, and the like. The heating section 11 of the base 10 may also be made of other materials capable of being processed by laser or the like to have a plurality of holes with a predetermined regular arrangement. The quartz glass, as well as other materials, can be engraved with a plurality of microholes or holes arranged according to a predetermined rule by means of processing such as a laser.

In some embodiments, the shape of the cross-section of the base 10 may be round, square, and the like. As shown in FIG. 1, when the shape of the cross-section of the base 10 is square, the width of the base 10 (the width W as shown in FIG. 1) may be, for example, about 3 mm±0.02, and the length of the base 10 (the length L as shown in FIG. 1) may be about 5 mm±0.02. It is to be understood herein that the dimensions of the base 10 may be other values based on the dimensions of the atomizing member.

In some embodiments, the thickness of the base 10 is in the range of 0.3 mm to 1.0 mm, for example, 0.5 mm. In the disclosure, the thickness of the base 10 refers to the thickness of the base 10 in a direction perpendicular to the plane shown in FIG. 1. The use of silicon wafers for the base 10 of the disclosure enables the heating element 1 to have a smaller volume and does not affect the strength of the base 10.

In some embodiments, the base 10 further comprises a recess 13 extending inwardly from the surface of the heating section 11 where the heating layer is provided for accommodating the temperature measurement device 20. By providing the recess 13 in the heating section 11 for accommodating the temperature measurement device 20, on the one hand, it is possible to isolate the temperature measurement device 20 from the heating layer to avoid a short circuit caused by the temperature measurement device 20 coming into contact with the heating layer, and on the other hand, it is possible to make the temperature measurement device 20 and the heating section 11 to be closer so as to more accurately obtain the temperature of the heating section 11 (more precisely, the heating layer).

In some embodiments, the temperature measurement device 20 may be a resistance temperature detector (RTD) or a thermocouple or the like, which, based on the property that the resistance value of a metal conductor or a semiconductor varies with temperature, converts the change in the resistance value into an electrical signal for the purpose of temperature measurement. The RTD or thermocouple temperature measurement is highly sensitive, stable and accurate. In some examples, the resistance value of the thermocouple or RTD is, for example, about 20 Ω.

Alternatively, where the base 10 employs a silicon wafer, the PN junction can be used as the temperature measurement device 20 by doping the silicon wafer to form a PN junction, thereby utilizing the temperature sensitivity of the PN junction.

In some embodiments, the base 10 further comprises an assembly section 12. The assembly section 12 is at least partially disposed around the heating section 11. The assembly section 12 of the base 10 is not subjected to any machining and does not have any wiring arranged thereon, so as to be used for assembling the assembly section 12 with, for example, a corresponding component of an atomizing member, thereby achieving the assembly of the heating element 1 into the atomizing member.

In some embodiments, each of the plurality of holes 14 within the heating section 11 of the base 10 has a diameter in the range of 30 μm to 100 μm, so as to allow the plurality of holes to realize conduction and locking of e-liquid. Specifically, on the one hand, the atomizing substance can be adsorbed and guided through the plurality of holes, and on the other hand, the tension of the atomizing substance, such as e-liquid, can avoid the liquid from entering the atomizing channel through the heating element 1, thereby reducing the risk of leakage.

In some embodiments, the minimum distance between neighboring holes in the plurality of holes 14 is in the range of 30 μm to 100 μm. The minimum distance of adjacent holes in the plurality of holes is the closest distance between the edges of two adjacent holes. The above dimensions may facilitate uniform distribution of a sufficient number of holes within the base 10 to ensure uniformity of conduction of the atomizing substance as well as storage of the amount of the atomizing substance.

In some embodiments, the heating layer on the surface of the heating section 11 of the base 10 is formed by plating (e.g., electroplating, vaporizing, etc.) a metal onto the surface of the heating section 11 so as to facilitate formation of the heating layer on the surface of the heating section. When the base 10 utilizes a silicon wafer, the heating layer with a lower resistance value can be accurately processed on the heating section 11. In some examples, the resistance of the heating layer may range from 0.4 Ωto 2.0 Ω. Optionally, the resistance of the heating layer may also be set to other values as desired.

In some embodiments, the heating layer may, for example, be made of a metal such as tungsten, iron-chromium-aluminum, or nickel-chromium alloy material.

In some other embodiments, where the base 10 employs a silicon wafer, the surface of the heating section 11 may be electrically conductive by doping to form a heating layer.

In some embodiments, the heating element further comprises a first electrode contact 31, a second electrode contact 32, and a third electrode contact 33. The first electrode contact 31 (e.g., a positive contact) and the second electrode contact 32 (e.g., a negative contact) are coupled to the heating layer, and the second electrode contact 32 and the third electrode contact 33 are coupled to the temperature measurement device 20. Thus, the heating layer and the temperature measurement device 20 share the second electrode contact 32 (e.g., a negative contact), simplifying the structure of the heating element 1.

In some examples, the first electrode contact 31 and the second electrode contact 32 are connected to a positive electrode and a negative electrode of a power source to supply power to the temperature measurement device 20 and the heating layer.

In some embodiments, the third electrode contact 33 for the temperature measurement device 20 is used for tamper-evident identification as well as for transmitting the temperature measurement signal of the temperature measurement device 20. In the case where the temperature measurement device 20 is an RTD, the temperature measurement signal may be a resistance signal. That is, the resistance change signal measured by the temperature measurement device 20 can be read from the third electrode contact 33 to obtain the temperature change of the heating element 11. Moreover, the third electrode contact 33 may also carry anti-counterfeiting information to facilitate anti-counterfeiting identification as an atomizing member.

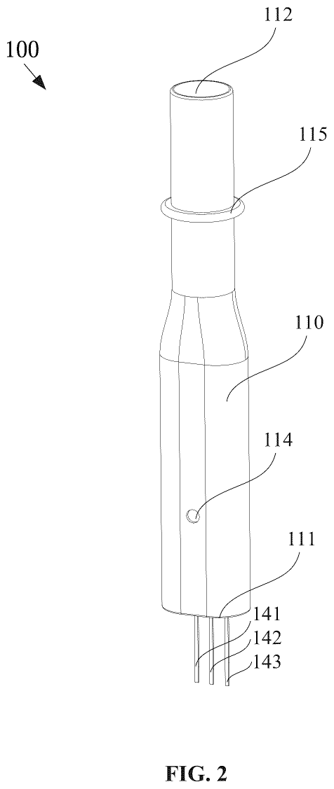

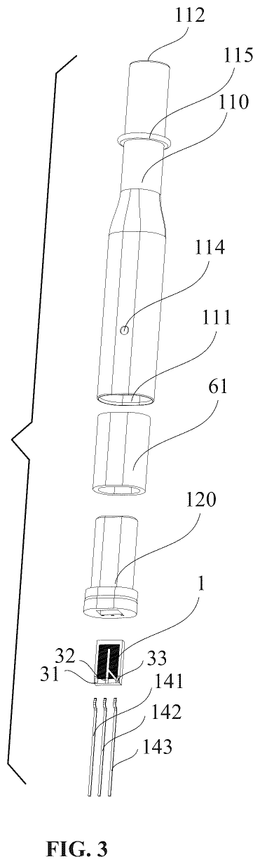

According to another aspect of the disclosure, as shown in FIGS. 2 to 3, there is also provided an atomizing member 100 comprising a cartridge 110, an atomizing base 120, and a heating element 1 described with reference to FIG. 1 above.

The cartridge 110 comprises an air inlet 111, an air outlet 112, an accommodation space 113 between the air inlet 111 and the air outlet 112, and an atomizing substance inlet 114 communicating with the accommodation space 113.

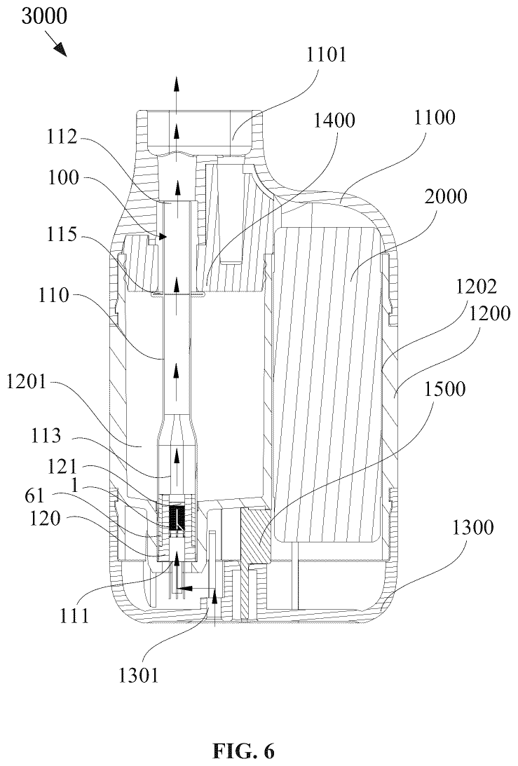

The atomizing substance inlet 114 is formed in and through the wall of the cartridge 110 so that the space outside of the cartridge 110 and the accommodation space 113 (shown in FIG. 6) can be connected to allow an atomizing substance disposed outside of the cartridge 110 to be accessible to the interior of the cartridge 110.

As shown in FIG. 6, the atomizing base 120 is disposed within the accommodation space 113, and the atomizing base 120 comprises an atomizing channel 121 for communicating with the air inlet 111 and the air outlet 112. The cavity in the approximate center of the atomizing base 120 forms the atomizing channel 121 for the flowing of air, steam, and aerosols. When the atomizing base 120 is mounted within the accommodation space 113 of the cartridge 110, one end of the atomizing channel 121 communicates with the air inlet 111 of the cartridge 110 and the other end communicates with the air outlet 112.

The atomizing base 120 further comprises an opening (not shown in the drawings) for connecting the atomizing substance inlet 114 and the atomizing channel 121. Since the opening is formed in and through the side wall of the atomizing base 120, the opening is opposite to the atomizing substance inlet 114 and passes into the atomizing channel 121, so an atomizing substance disposed outside of the cartridge 110 can enter the atomizing channel 121 through the atomizing substance inlet 114 and the opening 122.

The heating element 1 is disposed in the atomizing base 120 with the heating layer facing the atomizing channel 121 and the surface of the heating element 1 opposite to the heating layer facing the atomizing substance inlet 114. In this way, the atomizing substance entering through the atomizing substance inlet 114 (and the opening 122) reaches the heating element 1 and penetrates into the heating layer through a plurality of holes in the base 10 of the heating element 1 in order to be heated by the heating layer and to be atomized to forming an aerosol.

In the above embodiment, as shown in FIG. 6, when a user is vaping at the air outlet 112, the airflow can reach the air outlet 112 from the air inlet 111 via the atomizing channel 121 in the atomizing base 120, thereby forming an airflow pathway. A portion of the airflow pathway (i.e., the atomizing channel 121) forms the atomization chamber. One side of the heating element 1 is connected to the atomizing substance inlet 114 via the opening, and the other side is connected to the atomizing channel 121. The atomizing substance outside the cartridge 110 permeates through the atomizing substance inlet 114 and the opening to the base 10 of the heating element 1, and subsequently continues to permeate at the heating layer of the heating element 1, thereby reaching the heating layer on the first surface of the heating element 1, where it is heated and atomized by the heating layer to form vapor. The vapor is entrained in the air flowing through the atomizing channel 121 to form an aerosol for the user to vape.

In some embodiments, the heating element 1 is disposed in the opening of the atomizing base 120, and the opening may be provided with steps for supporting the heating element 1.

In the above circumference, the surface of the base 10 opposite to the heating layer directly covers the atomizing substance inlet 114. As a result, the base 10 acts as a buffer structure between the heating layer and the atomizing substance, avoiding the atomizing substance (e.g., e-liquid) from impacting the heating layer in the event of a too fast flow rate, which causes the e-liquid to enter the atomizing channel 121 directly without atomization, but instead be guided to be heated at the heating layer through the plurality of holes 14 of the base 10, thus promoting the uniformity of the heating. By using the base 10 of the heating element 1 as a guiding buffer structure between the atomizing substance inlet 114 and the heating layer without additionally providing an absorbing material 61, the number of components is reduced and the manufacturing cost is lowered.

Alternatively, to further minimize the risk of leakage, as shown in FIG. 3, the atomizing member further comprises a sleeve-shaped absorbing material 61. The absorbing material 61 is socketed to the atomizing base 120 (specifically, on the periphery of the atomizing base), and the outer side of the absorbing material 61 is covered from the inner side of the cartridge 110 over the atomizing substance inlet 114 and the inner side of the absorbing material 61 is affixed to the heating element 1. As a result, the cushioning structure provided between the heating element 1 and the atomizing substance avoids the atomizing substance (e.g., e-liquid) from impacting the heating element 1 at a flow rate that is too fast, which may cause the e-liquid to enter the atomizing channel 121 directly without atomization.

Alternatively, the atomizing member further comprises a sheet-shaped absorbing material 61, which is likewise disposed between the cartridge and the atomizing base. In this way, the first side of the absorbing material covers the atomizing substance inlet 114 from the inside of the cartridge 110, and the second side thereof opposite the first side is affixed to the heating element 1.

In some other embodiments, the heating element 1 is disposed within the atomizing channel 121 of the atomizing base 120, and the absorbing material is a sheet-like structure embedded within the opening of the atomizing base 120 and disposed between the atomizing substance inlet 114 and the heating element 1. The first side of the absorbing material covers the atomizing substance inlet 114 from the inside of the cartridge 110, and the second side thereof opposite the first side abuts the heating element 1. As a result, the cushioning structure provided between the heating element 1 and the atomizing substance avoids the atomizing substance (e.g., e-liquid) from impacting the heating element 1 at a flow rate that is too fast, which may cause the e-liquid to enter the atomizing channel 121 directly without atomization.

The absorbing material in the various aforementioned embodiments is cotton or spun cloth, which includes, but is not limited to, hygienic cotton, inert cotton, organic cotton, composite cotton, linen cotton, asbestos, and fiber cotton. The cotton or spun cloth comprises fibers, which can absorb or conduct e-liquid, so as to better achieve the effect of cushioning and avoiding oil excess. In addition, the cotton is characterized by a uniform distribution of pores, resulting in smoother e-liquid conduction.

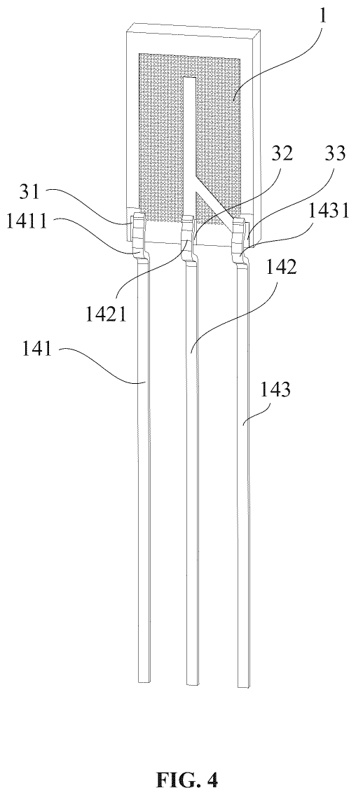

In some embodiments, the heating element 1 comprises a plurality of electrode contacts (e.g., a first electrode contact 31, a second electrode contact 32, and a third electrode contact 33) disposed on the surface of the heating section having a heating layer, and the atomizing member 100 further comprises a plurality of electrodes that are respectively in contact with the plurality of electrode contacts, and the ends of the plurality of electrodes in contact with the plurality of electrode contacts are the electrode springs. For example, as shown in FIGS. 3 and 4, the plurality of electrodes comprises a first electrode 141, a second electrode 142, and a third electrode 143. The first electrode spring 1411 of the first electrode 141 is in contact with the first electrode contact 31. The second electrode spring 1421 of the second electrode 142 is in contact with a second electrode contact 32. The third electrode spring 1431 of the third electrode 143 is in contact with the third electrode contact 33. By setting the end portion of the electrode as an electrode spring, i.e., an elastic electrode, it is possible to realize that the electrode spring is directly contacted with the electrode contact on the heating element for electrical connection without welding or the like.

Alternatively, the ends of the plurality of electrodes may not be provided with electrode springs, but may be electrically connected to the electrode contacts on the heating element by means of lead welding or the like.

In some embodiments, the plurality of electrodes extends at least partially out of the cartridge 110 to facilitate electrical connection with a battery module, a control part, etc., thereby facilitating power supply to, for example, the heating layer and the temperature measurement device, etc., and/or facilitating control of the heating element by the control part.

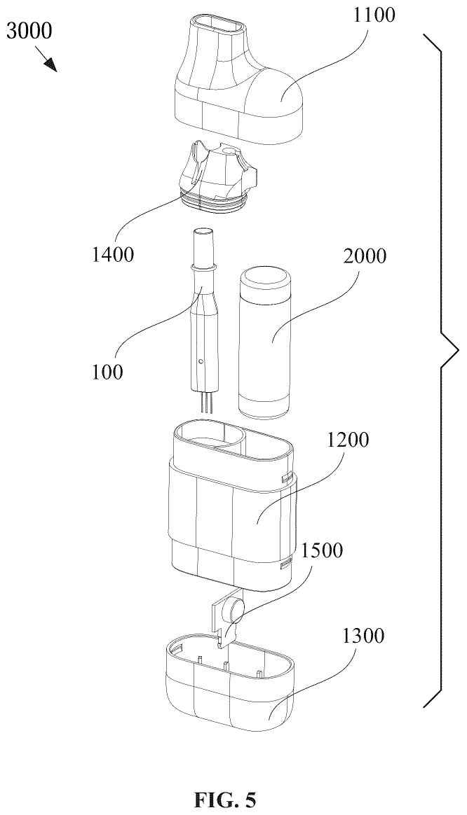

In some embodiments, as shown in FIGS. 2 and 3, a flange 115 (e.g., a flange provided at least partially along a circumferential direction of the cartridge) is disposed on the portion of the cartridge 110 near the air outlet 112 for the restriction of the seal element 1400 (as shown in FIG. 6) sleeving the cartridge 110. The above embodiment may facilitate the installation of the seal element, thereby facilitating the sealing of the storage chamber of the atomizing device (as will be described in detail below with reference to FIG. 6). According to still another aspect of the disclosure, as shown in FIGS. 5 and 6, there is provided an atomizing device comprising: the atomizing member 100 as described above and a housing (e.g., comprising a top cover 1100, a main body 1200, and a bottom cover 1300); the atomizing member 100 is disposed within the housing, and a storage chamber 1201 for storing an atomizing substance is formed between the housing (specifically, the inner wall of the housing) and the atomizing member (specifically, the outer wall of the atomizing member).

In some embodiments, the housing comprises: a top cover 1100, a main body 1200, and a bottom cover 1300. The top cover 1100 comprises a mouthpiece 1101 connected to the air outlet of the atomizing member 100. The bottom cover 1300 comprises an air intake connected to the air inlet 111 of the atomizing member 100. The main body 1200 is disposed between the top cover 1100 and the bottom cover 1300 and is used to house the atomizing member 100, thereby facilitating the support of the atomizing member within the housing and the formation of the storage chamber for storing the atomizing substance. The storage chamber is defined by a space between the inner wall of the main body, the inner wall of the top cover, and the outer wall of the cartridge of the atomizing member.

In some other embodiments, the housing is a one-piece housing.

In some embodiments, the atomizing device comprises a seal element 1400; the seal element 1400 sleeves the cartridge 110 of the atomizing member 100 and is disposed between the top cover 1100 and the main body 1200. The storage chamber 1201 is enclosed by the seal element 1400 (specifically, the bottom surface thereof), the main body 1200 (specifically, the inner wall thereof), and the atomizing member 100 (specifically, the outer wall thereof) (i.e., the space formed between the three components). The seal element described above for the cartridge 110 facilitates the sealing of the storage chamber enclosed. In some examples, the seal element 1400 is made of a gel. Additionally, a material for adsorbing the atomizing substance, such as, for example, liquid-locking cotton, may be placed within the storage chamber.

In some embodiments, as shown in FIG. 6, the bottom of the seal element 1400 may rest against the flange 115 of the cartridge 110 to limit the seal element.

In the embodiments described above, the atomizing substance within the storage chamber 1201 may enter the cartridge 110 via the atomizing substance inlet 114. Inside the cartridge 110, the atomizing substance is adsorbed by the absorbing material 61 and then passed through a plurality of holes on the heating element 1 to the heating layer of the heating element 1. The heating layer heats and atomizes the transferred atomizing substance. As the user inhales at the mouthpiece 1101, air may enter the interior of the electronic cigarette along the air inlet 1301 on the bottom cover 1300 and enter the atomizing channel 121 of the atomizing member 100 from the airflow inlet 111. At this point, the air and the atomized substance is inhaled by the user via the cartridge 110 at the mouthpiece 1101.

In some embodiments, the main body 1200 is provided with through holes at positions corresponding to the plurality of electrodes (e.g., the first electrode 141, the second electrode 142, and the third electrode 143), and the plurality of electrodes pass through the through holes of the main body 1200 and then are electrically connected to the power supply assembly via the control part, thereby forming an energized circuit between the heating element and the power supply assembly.

In some embodiments, a battery chamber 1202 arranged side-by-side with the storage chamber 1201 is also provided within the main body 1200 for placing a battery module 2000. As a result, the storage chamber for storing the atomizing substance and the battery chamber for placing the battery module can be integrated into a single housing, thereby reducing the number of components of the atomizing device and even the e-cigarette. According to yet another aspect of the disclosure, as shown in FIG. 6, there is provided an e-cigarette 3000 comprising: the atomizing device as described above and a battery module 2000 (e.g., an electric cartridge) for powering the atomizing device.

In some embodiments, the electronic cigarette further comprises a control part 1500 (e.g., a PCB circuit board, etc.) disposed within the main body (e.g., on the bottom cover 1300) of the atomizing device. An external circuit is integrated on the control part 1500 for controlling the energization circuit between the battery module and the heating element. The control part may control powering of the heating element by the battery module based on input control parameters (e.g., control parameters input by a user, changes in air pressure within the e-cigarette, and/or temperature of the heating layer measured by a temperature measurement device, etc.). Specifically, for example, a button is disposed on an outer surface of the electronic cigarette for a user to input the control parameters to control the heating of the heating element. In addition, an airflow sensor is also disposed at the airflow inlet and/or air intake for monitoring changes in air pressure within the electronic cigarette.

It will be obvious to those skilled in the art that changes and modifications may be made, and therefore, the aim in the appended claims is to cover all such changes and modifications.

What is claimed is:

1. A heating element for atomizing an atomizing substance to form an aerosol, the heating element comprising:
a base, the base comprising a heating section, the heating section comprising a surface, a heating layer disposed on the surface, and a plurality of holes arranged in a predetermined pattern, the plurality of holes being configured to adsorb an atomizing substance and direct the adsorbed atomizing substance to the heating layer; and
a temperature measurement device, the temperature measurement device being disposed on the base for measuring a temperature of the heating section.

2. The heating element of claim 1, wherein the base comprises silicon wafer.

3. The heating element of claim 1, wherein the base further comprises a recess extending inwardly from the surface of the heating section to accommodate the temperature measurement device.

4. The heating element of claim 1, wherein the base further comprises an assembly section at least partially disposed around the heating section.

5. The heating element of claim 1, wherein the base has a thickness of 0.3-1.0 mm.

6. The heating element of claim 1, wherein each of the plurality of holes has a diameter of 30-100 μm.

7. The heating element of claim 1, wherein a minimum distance between every two adjacent holes in the plurality of holes is in the range of 30 to 100 μm.

8. The heating element of claim 1, wherein the heating layer is formed by plating metal onto the surface of the heating section.

9. The heating element of claim 1, further comprising a first electrode contact, a second electrode contact, and a third electrode contact disposed on the surface of the heating section; wherein the first electrode contact and the second electrode contact are electrically connected to the heating layer, and the second electrode contact and the third electrode contact are electrically connected to the temperature measurement device.

10. The heating element of claim 9, wherein the third electrode contact is used for anti-counterfeiting identification and transmitting temperature measurement signals of the temperature measuring device.

11. An atomizing member, comprising:
a cartridge, the cartridge comprising an airflow inlet, an airflow outlet, and an accommodation space and an atomizing substance inlet between the airflow inlet and the airflow outlet, the accommodation space communicating with the atomizing substance inlet;
an atomizing base disposed in the accommodation space, the atomizing base comprising an atomizing channel and an opening, both the atomizing channel and the opening communicating with the airflow inlet and the airflow outlet, and the opening communicating with the atomizing substance inlet and the atomizing channel; and
the heating element of claim 1 disposed in the atomizing base, the heating layer facing the atomizing channel, a surface of the heating element opposite the heating layer facing the atomizing substance inlet.

12. The atomizing member of claim 11, wherein the heating element further comprises a plurality of electrode contacts disposed on the surface of the heating section; and the atomizing member further comprises a plurality of electrodes fixedly connected to the plurality of electrode contacts, respectively; ends of the plurality of electrodes comprise electrode springs in contact with the plurality of electrode contacts, respectively.

13. The atomizing member of claim 11, wherein a flange is disposed on a portion of the cartridge near the airflow outlet for restriction of a seal element sleeving the cartridge.

14. The atomizing member of claim 11, wherein the heating element is disposed in the opening; the atomizing member further comprises a sleeve-shaped absorbing material; the absorbing material is socketed to the atomizing base, and an outer side of the absorbing material is covered from an inner side of the cartridge over the atomizing substance inlet and an inner side of the absorbing material is affixed to the heating element.

15. An atomizing device, comprising:
the atomizing member of claim 11, and
a housing, the atomizing member being disposed in the housing, and a storage chamber being formed between the atomizing member and the housing to accommodate the atomizing substance.

16. The atomizing device of claim 15, wherein the housing comprises: a top cover, a main body, and a bottom cover; the top cover comprises a mouthpiece connected to the airflow outlet of the atomizing member; the bottom cover comprises an air intake connected to the airflow inlet of the atomizing member; the main body is disposed between the top cover and the bottom cover and is used to house the atomizing member.

17. The atomizing device of claim 16, wherein the atomizing device comprises a seal element; the seal element sleeves the cartridge of the atomizing member and is disposed between the top cover and the main body; and the storage chamber is enclosed by the seal element, the main body, and the atomizing member.

18. The atomizing device of claim 16, wherein a battery chamber arranged side-by-side with the storage chamber is also disposed in the main body for receiving a battery module.

19. An electronic cigarette, comprising:
the atomizing device of claim 15, and
a power supply for supplying power for the atomizing device.
